(19) United States
(12) Patent Application Publication
(10) Pub. No.: US 2019/0347407 A1
(43) Pub. Date: Nov. 14, 2019

(54) DETECTING CLIENT-SIDE EXPLOITS IN WEB APPLICATIONS

(71) Applicant: CyberArk Software Ltd., Petach-Tikva (IL)

(72) Inventor: Evgeny BESKROVNY, Ramat Gan (IL)

(73) Assignee: CyberArk Software Ltd., Petach-Tikva (IL)

(21) Appl. No.: 15/975,147

(22) Filed: May 9, 2018

(51) Int. Cl. G06F 21/52; G06F 21/56

(52) U.S. Cl. CPC G06F 21/52; G06F 2221/033; G06F 21/566; G06F 21/563

(57) ABSTRACT

The disclosed embodiments include systems, methods, and computer-readable media configured to detect client-side exploits. The techniques described in the disclosed embodiments may be used to minimize the attack surface of the client devices. Thus, the techniques may be used to reduce injection-type cyberattacks on client devices by detecting anomalies occurring in the client devices. As a result, the disclosed embodiments reduce the vulnerabilities and weaknesses associated with web applications and other client applications.

### BACKGROUND

In a computer security context, client-side exploits and attacks involve targeting vulnerabilities and weaknesses on a user's computer system, such as a web browser or other application on a client machine. These client-side exploits arise because typical web application firewalls (WAFs) are unable to detect attacks occurring on a client-side browser and can only detect attacks on the server side. For instance, a client-side attack may cause malware to be installed on the client system that allows the attacker access to the user's computer system. Or the attack may execute malicious code without installing any malware on the user's computer system. These installation-free attacks may be injection-type attacks such as document object model (DOM) based cross-site scripting (XSS), client-side hypertext markup language (HTML) injection, and others.

With respect to XSS attacks, the client-side exploits may inject malicious scripts into otherwise benign and trusted web sites. For example, XSS attacks may occur when an attacker uses a web application to send malicious code, generally in the form of a browser-side script, to an end user. Flaws that allow these attacks to succeed are quite widespread and occur anywhere a web application generates an output using an input from a user without validating or encoding the input. By using XSS to send a malicious script to an unsuspecting user, the end user's browser has no way to know that the malicious script should not be trusted. The browser will execute the malicious script because it thinks the script came from a trusted source. Once executed, the malicious script can access any cookies, session tokens, or other sensitive information retained by the browser and used with that site. These malicious scripts can even rewrite the content of the HTML page.

Today, XSS attacks are detected via pattern recognition by a web application firewall (WAF) or a browser plugin. The WAF, for example, may inspect the payload of the server-bound request to assess suspicious patterns such as scripts or others as evidence that an XSS exploit is taking place. Furthermore, web developers often automate the build and deployment pipelines to allow code to be deployed into production in a relatively short amount of time (e.g., within minutes), and risks exist where developers may unintentionally or maliciously push harmful code into production without proper review or approval.

Accordingly, there is a need for technological solutions for improving the security of computer systems to detect potentially malicious activity in client-side applications.

### SUMMARY

The disclosed embodiments include systems, methods, and computer readable media configured to detect potential client-side exploits in web content. As discussed further below, the disclosed embodiments improve security of computer systems by enabling detection of potentially malicious activity in client-side applications.

In some disclosed embodiments, a system may be configured to detect potential client-side exploits in web content. For example, some disclosed embodiments may identify metadata associated with an element of web content. In one aspect, the element of web content, for example, may be an HTML page, a script application, etc. In another aspect, the metatdata may describe an initial plurality of attributes of the element of web content. For example, the initial plurality of attributes may specify a permitted range for the element of web content.

Some disclosed embodiments may further insert application code into the web content. In one aspect, the application code may be executable by a browser that processes the element of web content. In another aspect, the application code may be configured to determine a current plurality of attributes of the element of web content. In yet another aspect, the application code may be configured to periodically investigate the current plurality of attributes of the web content. For example, the application code may be configured to investigate the current plurality of attributes of the web content upon a browser loading the element of web content. In another example, the application code may be configured to investigate the current plurality of attributes of the web content upon a browser refreshing the element of web content. In yet another example, the application code may be configured to investigate the current plurality of attributes of the web content upon detecting changes in the element of web content.

In one aspect, the plurality of attributes may include a number or range of scripts in the element of web content. The plurality of attributes may also include a number or range of forms in the element of web content. Or the plurality of attributes may also include a number or range of frames in the element of web content.

In another aspect, the plurality of attributes may identify a uniform resource identifier in the element of web content. The plurality of attributes may also identify an external library that is used by the element of web content. Or the plurality of attributes may also identify a whitelisted uniform resource locator in the element of web content.

In yet another aspect, the plurality of attributes may identify types of uniform resource locators in the element of web content. The plurality of attributes may also identify types of scripts in the element of web content. Or the plurality of attributes may also identify types of forms in the element of web content.

Some disclosed embodiments may further compare the initial plurality of attributes of the element of web content to the current plurality of attributes of the element of web content. In one aspect, the disclosed embodiments may insert the metadata into the element of web content and perform the comparison by the inserted application code. In another aspect, the disclosed embodiments may receive the current plurality of attributes of the element of web content and perform the comparison external to the element of web content. In such an aspect, the metadata may be stored external to the element of web content. In another aspect, the current plurality of attributes of the element of web content may be received in response to an asynchronous JavaScript and XML (AJAX) call. For example, the AJAX call may include a prompt to perform the comparison. Based on the comparison, some disclosed embodiments may determine whether a potential client-side exploit exists in the element of web content.

It is to be understood that both the foregoing general description and the following detailed description are exemplary and explanatory only and are not restrictive of the disclosed embodiments as defined in the claims.

### BRIEF DESCRIPTION OF DRAWINGS

The accompanying drawings, which are incorporated in and constitute a part of this specification, illustrate disclosed embodiments and, together with the description, serve to explain the disclosed embodiments. In the drawings:

FIG. 1 is a schematic diagram of an exemplary system that may be used to detect potential client-side exploits in web content in accordance with disclosed embodiments.

FIG. 2 is a schematic diagram of an exemplary electronic device that may be used to detect potential client-side exploits in web content in accordance with disclosed embodiments.

FIG. 3 is a schematic diagram of exemplary elements of web content in accordance with disclosed embodiments.

FIG. 4 is an exemplary depiction of metadata describing various properties of interest for client-side exploits in accordance with disclosed embodiments.

FIG. 5 is flow chart illustrating an exemplary sequence of steps that may be used to detect potential client-side exploits in web content in accordance with disclosed embodiments.

FIG. 6 is a flow chart illustrating an exemplary sequence of steps that may be used to detect potential client-side exploits in web content in accordance with disclosed embodiments.

FIG. 7 is an exemplary application code that may be used to detect potential client-side exploits in web content in accordance with disclosed embodiments.

### DETAILED DESCRIPTION

In the following detailed description, numerous specific details are set forth in order to provide a thorough understanding of the disclosed example embodiments. However, it will be understood by those skilled in the art that the principles of the example embodiments may be practiced without every specific detail. Well-known methods, procedures, and components have not been described in detail so as not to obscure the principles of the example embodiments. Unless explicitly stated, the example methods and processes described herein are neither constrained to a particular order or sequence, nor constrained to a particular system configuration, Additionally, some of the described embodiments or elements thereof can occur or be performed simultaneously, at the same point in time, or concurrently. Reference will now be made in detail to the disclosed embodiments, examples of which are illustrated in the accompanying drawings. Unless explicitly stated, sending and receiving as used herein are understood to have broad meanings, including sending or receiving in response to a specific request or without such a specific request. These terms thus cover both active forms, and passive forms, of sending and receiving.

The disclosed embodiments provide improved techniques for reducing the risk of client-side exploits and, more particularly, systems, methods, and computer readable media to detect potential client-side exploits in web content. The described systems, methods, and computer readable media minimize risk of client-side exploits by detecting potential client-side exploits in web content, and further minimize the potential attack surface of a client-side device.

Reference will now be made in detail to exemplary disclosed embodiments, examples of which are illustrated in the accompanying drawings and disclosed herein. Where convenient, the same reference numbers will be used throughout the drawings to refer to the same or like parts.

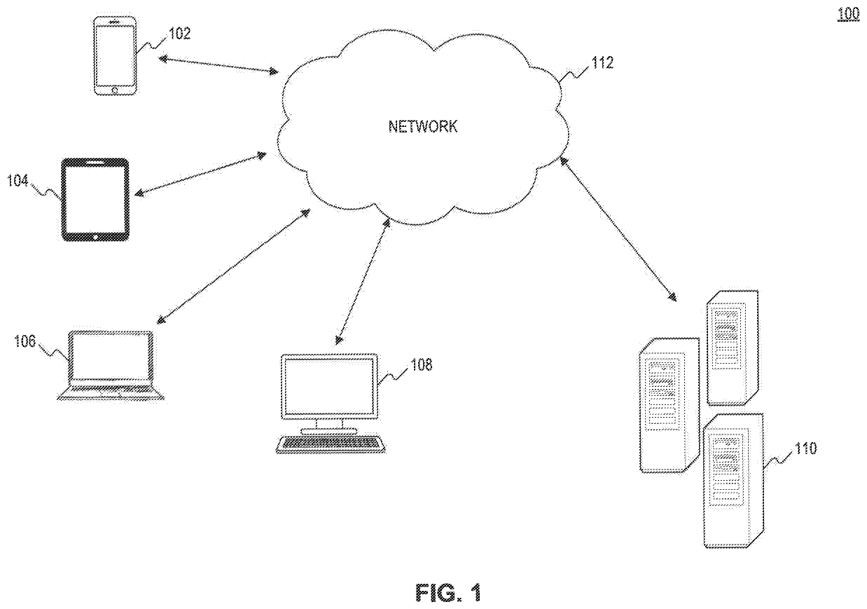

FIG. 1 shows a diagram of an exemplary system 100 for performing one or more operations in accordance with the disclosed embodiments, as discussed further below. The system 100 may comprise various components, including one or more computing devices 102, 104, 106, 108, 110 such as mobile computing devices, computers, web servers, general-purpose servers, authentication servers, etc. Devices in the system 100 may further include memories for storing data and/or software instructions, such as RAM, ROM, databases, or other computer memory devices, or the like.

According to some embodiments, the system 100 may include one or more mobile computing devices 102, 104, 106 of various sizes and configurations. As used herein, the term “mobile computing device” broadly includes any portable computing device having at least one processor, memory, and a capability for data communication. Mobile computing devices may include, but are not limited to, a mobile phone, smartphone, personal digital assistant, tablet, laptop, portable device, IoT device, smart appliance, home automation device, vehicle infotainment system, etc. Although the mobile computing devices 102, 104, 106 are shown as a smartphone 102, tablet 104, and laptop 106 for exemplary purposes in this description, it will be understood that other types of portable computing devices may also or alternatively be used in embodiments in accordance with this disclosure.

In some embodiments, the system 100 may also include one or more computing devices 108, 110 such as a desktop computer, workstation, server, web server, application server, etc. It will be apparent to those skilled in the art that the computing devices 108, 110 include at least one processor, memory for storing data and/or software instructions, and one or more user input/output devices. A server further provides functionality for other computing devices. As used herein, the term “web server” broadly includes any server configured to serve Hypertext Transfer Protocol (HTTP) content, and the term “application server” broadly includes any server configured to support application level services.

The mobile computing devices 102, 104, 106 and computing devices 108, 110 in the system 100 may be configured to communicate with one or more components in the system 100 via a network 112. The network 112, in some embodiments, may comprise one or more interconnected wired or wireless data networks. In one aspect, the network 112 may comprise any type of computer networking arrangement used to exchange data. For example, the network 112 may be implemented using the Internet, a wired Wide Area Network (WAN), a wired Local Area Network (LAN), a wireless WAN (e.g., WiMAX), a wireless LAN (e.g., IEEE 802.11, Bluetooth, etc.), a mobile network, a private data network, a virtual private network using a public network, and/or other suitable connection (e.g., NFC, infrared, etc.) that enables the system 100 to send and receive information between the components in the system 100. In some embodiments, the system 100 may be a web application computing system where one or more mobile computing devices 102, 104, 106 and computing devices 108, 110 are interconnected via the network 112.

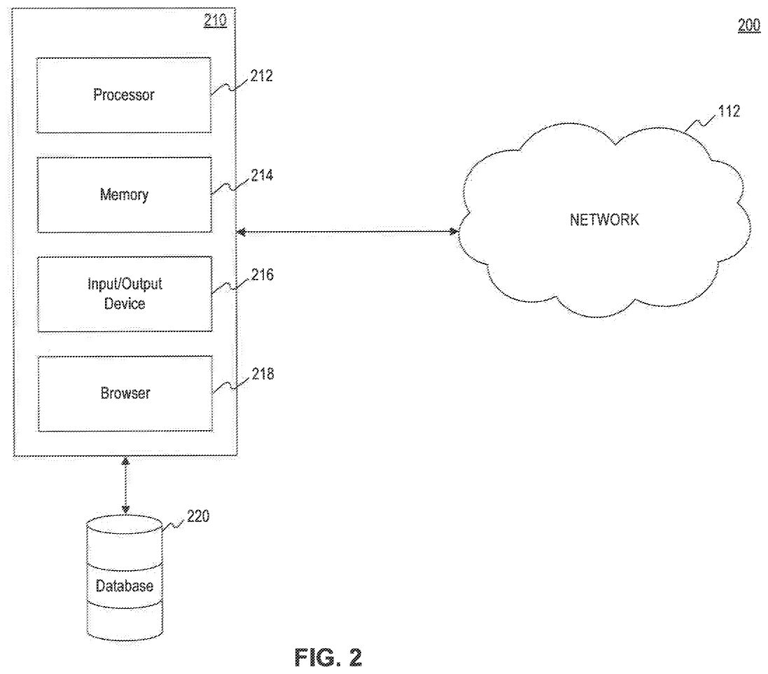

FIG. 2 shows a diagram of another exemplary system 200 for performing one or more operations in accordance with the disclosed embodiments. The exemplary system 200 or variations thereof may be implemented by one or more of the components in the system 100 (shown and not shown), including mobile computing devices 102, 104, 106 and computing devices 108, 110.

In some embodiments, the system 200 may include a computing device 210 having one or more processors 212, one or more memories 214, one or more input/output (I/O) devices 216, one or more browsers 218, and one or more databases 220. In some embodiments, the system 200 may take the form of a mobile computing device, a personal computer, a mainframe computer, a server, or any combination of these components. Alternatively, the computing device 210 may be configured as a particular apparatus, embedded system, dedicated circuit, or the like based on the storage, execution, and/or implementation of the software instructions that perform one or more operations in accordance with the disclosed embodiments. In some embodiments, the system 200 may be a system-on-a-chip (SoC). Furthermore, the system 200 may be a stand-alone system, or it may be implemented as a subsystem in a larger system, where one or more operations in the system 200 are performed using parts of the larger system.

Processor(s) 212 may include one or more data or software processing devices. For example, the processor(s) 212 may take the form of, but not limited to, a microprocessor, embedded processor, or the like, or alternatively, the processor(s) 212 may be integrated in an SoC. Furthermore, according to some embodiments, the processor(s) 212 may be from the family of processors manufactured by Intel®, AMD®, Qualcomm®, Apple®, NVIDIA®, or the like. The processor(s) 212 may also be based on the ARM architecture, a mobile processor, or a graphics processing unit, etc. The disclosed embodiments are not limited to any type of processor configured in the computing device 210.

Memory 214 may include one or more storage devices configured to store instructions used by the processor(s) 212 to perform functions related to the disclosed embodiments. For example, the memory 214 may be configured to store software instructions, such as programs, that perform one or more operations when executed by the processor(s) 212 to disable one or more application interface elements for an application running in a restricted mode. The disclosed embodiments are not limited to software programs or devices configured to perform dedicated tasks. For example, the memory 214 may include a single program, such as a user-level application, that performs the functions of the disclosed embodiments, or may comprise multiple software programs. Additionally, the processor 212 may execute one or more programs (or portions thereof) remotely located from the computing device 210. Furthermore, the memory 214 may include one or more storage devices configured to store data for use by the programs.

I/O devices 216 may include one or more integrated ports or stand-alone devices configured to allow data to be received and/or transferred by the computing device 210. In some embodiments, the I/O devices 216 may comprise a touchscreen configured to allow a user to interact with the computing device 210, and in some embodiments, the I/O devices 216 may comprise a keyboard, mouse, trackball, touch pad, stylus, and the like. The I/O devices 216 may include one or more communication devices and/or interfaces (e.g., WiFi, Bluetooth®, RFID, NFC, RF, infrared, etc.) to communicate with other machines and devices, such as the components in the system 100. I/O devices 216 may also comprise sensors, such as gyroscopes, accelerometers, thermometers, cameras, scanners, etc.

Browsers 218 (or web browser) are software programs for accessing content on the network 112. For example, the browsers 218 may be Chrome™, Firefox™, Safari™, Internet Explorer™, Edge™, Opera™, or the like. Browser 218 renders HTML contents for display on a display device of the system 200. For example, the browser 218 may process a plurality of components of the HTML contents, such as scripts, forms, frames, libraries, JavaScript functions, etc. Modern browsers may also process components such as AJAX functions, CSS, cookies, etc. In further embodiments, additional applications may also be running on computing device 210.

The system 200 may be configured to communicate with one or more components in the system 100 via a network 112. For example, the system 200 may be connected to a web server and/or an application server in the system 100 via the network 112.

It is to be understood that the configurations and boundaries of the functional building blocks shown for exemplary systems 100 and 200 have been generally described herein for the convenience of the description, Alternative implementations may be used so long as the specified functions and relationships thereof are appropriately performed and fall within the scope and spirit of the various embodiments, as discussed further below.

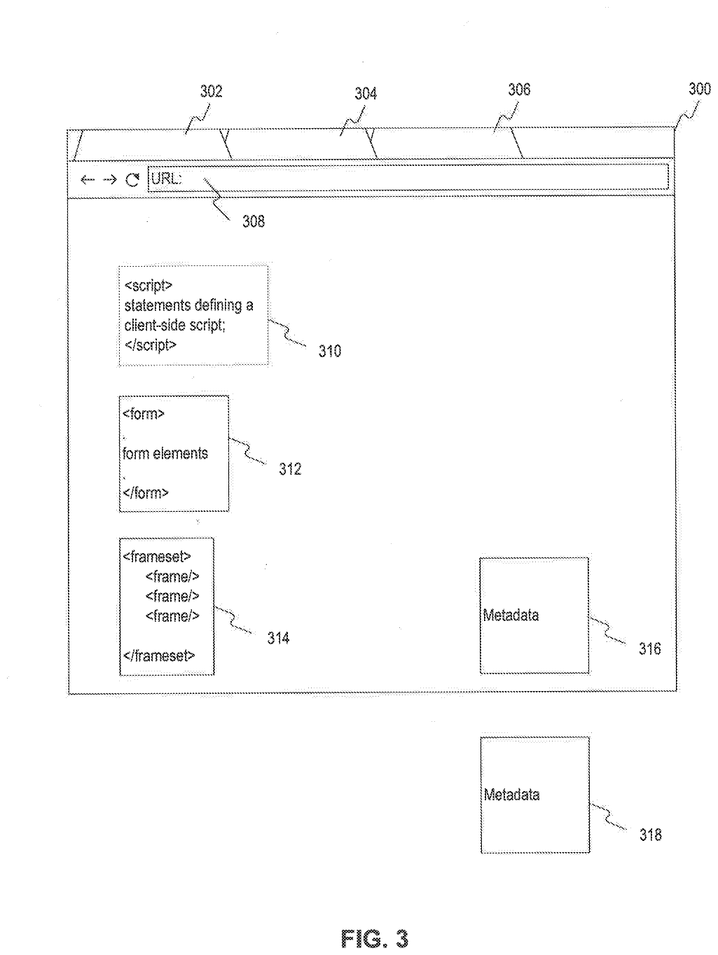

FIG. 3 shows a schematic diagram of an exemplary browser 300 in accordance with the disclosed embodiments. For purposes of explanation and not limitation, the following exemplary browser 300 or variations thereof are described in the context of systems 100 and 200, such that the disclosed browser may be implemented by software executing in mobile devices 102, 104, 106, and/or computing devices 108, 110.

Browser 300 may enable a user to open multiple web pages at the same time, either in different browser windows or in different tabs 302, 304, 306 of the same window. Browser 300 retrieves an element of web content for display on the mobile devices 102, 104, 106, and/or computing devices 108, 110. For example, the element of web content may be an HTML page, a script application, or the like. In one aspect, the element of web content may contain various components such as scripts 310, forms 312, frames 314, action URI, external libraries, URL, etc. In another aspect, the element of web content may be associated with a metadata 316, 318. For example, the metadata 316 may reside within the element of web content. In another example, the metadata 318 may be stored external to the element of web content.

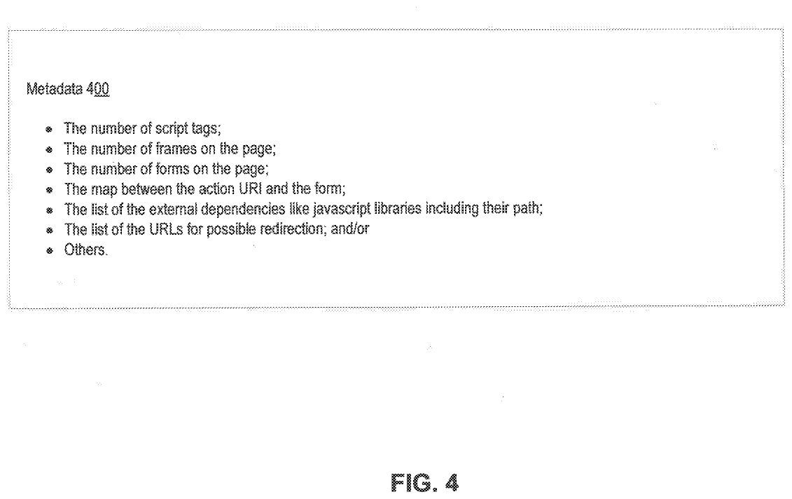

FIG. 4 shows a schematic diagram of an exemplary metadata 400 in accordance with disclosed embodiments. For purposes of explanation and not limitation, the following describes the exemplary metadata 400 or variations thereof in the context of systems 100 and 200, such that the metadata may be implemented by software executing in mobile devices 102, 104, 106, and/or computing devices 108, 110.

In some embodiments, the metadata 400 may be generated while creating a web application. In such embodiments, creating the application (and application code) and generating the metadata 400 may be performed by the same service. In some embodiments, creating the application (and application code) and generating the metadata 400 may be performed by different services.

Metadata 400 may contain relevant data and information with respect to the web application that is of interest to a potential cyberattack. In one aspect, the metadata 400 may describe a list of properties that may be of interest for the potential client-side exploits. For example, the metadata 400 may describe the web application (or web page) in terms of the number of script tags, number of frames, the number of forms, action URIs (uniform resource identifiers), external libraries, whitelist of the URLs to redirect to, and other important properties that attackers uses to attack the web application. In further embodiments, metadata 400 may describe various other attributes and characteristics of the web application, web page, or associated application.

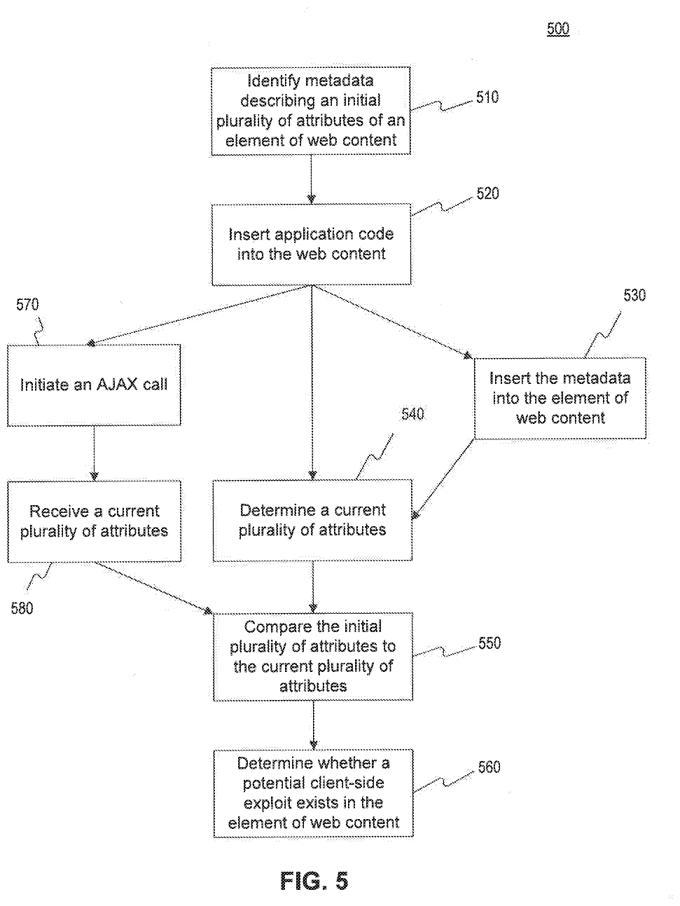

FIG. 5 shows a flow chart illustrating an exemplary process 500 that may be used to detect potential client-side exploits in web content in accordance with the disclosed embodiments. The process 500 of FIG. 5 may be implemented in software, hardware, or any combination thereof. For purposes of explanation and not limitation, the process 500 will be described in the context in the context of system 100, such that the disclosed process may be performed by software executing in mobile devices 102, 104, 106, and/or computing devices 108, 110. In further embodiments, process 500 may be performed by a computing device remote from those depicted in system 100 (e.g., a separate server or group of servers).

In the aspect of detecting potential client-side exploits in web content, the system 100 may be configured to identify metadata describing an initial plurality of attributes of an element of web content, at step 510. In one aspect, the metadata may describe an initial plurality of attributes of the element of web content. In some embodiments, the metadata may be generated automatically via code analytic techniques. For example, the metadata may be generated via a static code analysis. In one aspect, the code analysis can look for certain key words such as certain HTML element tags, including but not limited to <script>, <form>, <frame>, etc. In some embodiments, the code analysis may count the number of occurrences in the code. For example, the metadata may identify scripts in the element of web content. In such an example, the metadata may describe a plurality of attributes identifying scripts in the element of web content. The plurality of attributes may also identify the types of scripts in the element of web content. The plurality of attributes may identify a number or range of scripts in the element of web content.

In another example, the metadata may identify forms in the element of web content. In such an example, the metadata may describe a plurality of attributes identifying forms in the element of web content. The plurality of attributes may also identify the types of forms in the element of web content. The plurality of attributes may identify a number or range of forms in the element of web content. Examples of forms may include user-fillable forms (e.g., such as found on e-commerce web sites), machine-Tillable forms (e.g., forms that are auto-completed by backend servers), and more.

In another example, the metadata may identify frames in the element of web content. In such an example, the metadata may describe a plurality of attributes identifying frames in the element of web content. The plurality of attributes may also identify the types of frames in the element of web content. The plurality of attributes may identify a number or range of frames in the element of web content. Examples of frames may be HTML frames, i-frames, or other types of separating mechanisms used in building web content. Frames may also separate content in other types of applications (e.g., Java™-based applications).

In another aspect, the code analysis may also identify other properties in the element of web content. For example, the code analysis may identify a uniform resource identifier or uniform resource locator. In such an aspect, the metadata may describe a plurality of attributes identifying a uniform resource identifier or locator in the element of web content. This may be identified, for example, if the code analysis reveals that a particular uniform resource identifier or locator is specifically referenced in the code or is part of another application to which the code makes a reference.

In another aspect, the code analysis may identify an external library that is used by the element of web content. For example, the code analysis may analyze the list of library references to create a list of the external libraries with their respective uniform resource locators. The external libraries may be, for example, external JavaScript™′ libraries. In such an aspect, the metadata may describe a plurality of attributes identifying an external library that is used by the element of web content.

In yet another aspect, the code analysis may identify a uniform resource locator in the element of web content. In such an aspect, the code analysis may add the identified uniform resource locator to a whitelist, and the metadata may describe a plurality of attributes identifying a whitelisted uniform resource locator in the element of web content. A whitelisted uniform resource locator may be one that a browser or other application is deemed to trust and is able to access. In another aspect, the metadata may describe a plurality of attributes identifying types of uniform resource locators in the element of web content. In some embodiments, the initial plurality of attributes may specify a permitted range for the element of web content.

In some embodiments, the system 100 may inject code into the element of web content to create the metadata. For example, the injected code may enumerate properties of the element of web content to create a metadata associated with the element of web content. The injected code may execute on the client device and have a function of analyzing the properties of the web content (e.g., an HTML page). Further, the injected code may be configured to report the results of its analysis back to a remote system or to store its analysis locally on the client device.

At step 520, the system 100 may insert application code into the web content. In such a way, the system 100 may augment the web content with the application code. In one aspect, the application code may be executed by the browser 218 that processes the element of web content. For example, the system may inject application code into the HTML page. In such an example, the application code may be a JavaScript™ code or various other types of code.

In some embodiments, the injection may be performed in a proxy or by a firewall, or any other intermediary entity that may reside between the browser and web server. In such embodiments, the intermediary entity may inject the application code into the element of web content. Thus, in some embodiments, the system 100 may optionally inject the metadata into the element of web content as well, at step 530. In such embodiments, the metadata would be stored in the element of web content. Alternatively, in some embodiments, the system 100 may store the metadata external to the element of web content. In such embodiments, the metadata would not be injected into the element of web content. For example, the metadata may be stored on the web server or the like.

In some embodiments, the original element of web content may comprise the application code and the metadata for detecting client-side exploits. For example, when the element of web content was first generated, the metadata may be generated based on the plurality of attributes of the web content. In other words, the original web page may contain the application logic, the embedded metadata describing the elements of the web page, and the JavaScript™ code for monitoring client-side exploits.

At step 540, the system 100 may determine a current plurality of attributes. In other words, the system 100 may check the entities currently running on the web content. For example, the system 100 may use the JavaScript code in the webpage to check the webpage's runtime properties to determine the current plurality of attributes associated with the webpage. As discussed above, various types of properties may be analyzed and identified, such as those relating to uniform resource identifiers or locators, forms, frames, etc.

At step 550, the system 100 may compare the initial plurality of attributes to the current plurality of attributes. For example, the system 100 may identify a mismatch between the metadata that describes the various expected properties of the web content with the runtime properties of the same web content. As an example, if an HTML page had an initial plurality of attributes including a fillable form with 10 fields, a mismatch may exist if the current plurality of attributes indicate a fillable form with 12 fields. Similarly, a mismatch may occur if the currently plurality of attributes include a uniform resource identifier or locator that was not present in the initial plurality of attributes.

At step 560, the system 100 may determine whether a potential client-side exploit exists in the element of web content based on the comparison. Should a mismatch exist between the initial plurality of attributes and the current plurality of attributes, the system 100 may perform a remedial action, including but not limited to disabling the runtime property, stopping the application, or some other responsive actions.

In the disclosed embodiments, the comparison process may be performed either on the client side, the server side, or by any service that may be external to both. For example, a web browser on the client's device may send a get request to receive an HTML webpage. In response to the get request, the web server may send an HTML webpage that contains a JavaScript™ code that detects potential client-side exploits. The HTML webpage may also have a metadata embedded in the webpage that describes an initial plurality of properties associated with the HTML webpage. The JavaScript™ may be configured to run in a time-based mode to periodically check the webpage's runtime properties to detect potential anomalies. In such an example, the original HTML webpage may contain the metadata and application code to detect client-side exploits on the client side.

In another example, the JavaScript™ code and/or metadata may be injected into the HTML webpage, so the client device may detect client-side exploits on the client side. The injection may be performed by the client device itself, or by an intermediary entity such as a proxy or a firewall that resides between the client device and the web server, or by the web server. As an example, the proxy, firewall, or web server may safeguard the system 100 by injecting the JavaScript™ code and/or metadata into the HTML webpage so the client's web browser may detect potential client-side exploits in the webpage's runtime properties.

In some embodiments, it is also possible for the external services (intermediary entity or web server) to perform the client-side-exploit detection external to the client devices. For example, the system 100 may initiate a call to the external services to perform the detection process. As an example, the JavaScript™ running in the client device may collect the runtime properties and send them to the external server for validation. In such an example, the external services may compare the current runtime properties with the properties described in the metadata to detect potential client-side exploits.

In some embodiments, the system 100 may use an AJAX function. For example, the system 100 may initiate an AJAX call, at step 570. The AJAX call may issue an HTTP request from the HTML webpage to the external services. At step 580, the system 100 may receive a current plurality of attributes in response to the AJAX call. Along with the AJAX call, for example, may be the current runtime properties of the HTML webpage. In such an example, the AJAX call may prompt the external services to compare the current runtime properties with the metadata. The external services may send a response to the AJAX call to indicate the status of the current runtime properties.

In sum, process 500 may be performed by any of the components in the system 100 to detect potential client-side exploits.

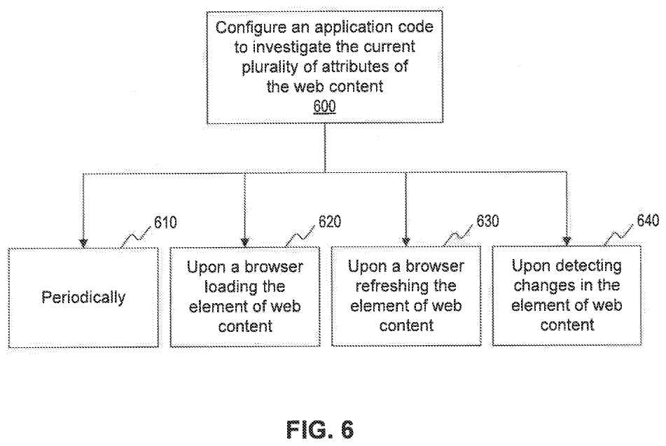

FIG. 6 is a flow chart illustrating an exemplary process 600 that may be used to develop a mapping associated with an application in accordance with the disclosed embodiments. The process of FIG. 6 may be implemented in software, hardware, or any combination thereof. For purposes of explanation and not limitation, the following describes exemplary process in the context of systems 100 and 200, such that the disclosed process 600 may be performed by software executing in mobile devices 102, 104, 106, and/or computing devices 108, 110.

In process 600, application code with a function to investigate the current plurality of attributes of the web content is configured. During the configuration process, the system 100 may configure the application code in a time-based mode or in an action-based mode. As discussed above, the application code may be injected into a client application (e.g., web browser) or may run as a standalone application on a client machine. Further, in some embodiments the application code executes remote from the client machine.

In some embodiments, at step 610, the system 100 may configure the application code to periodically investigate the current plurality of attributes of the web content, in such embodiments, the application code may run in a time-based mode. For example, the application code may wake up based on a predefined time or interval of time to investigate the current plurality of attributes of the web content. Correspondingly, the application code may be configured to periodically report the results of its analysis. Alternatively, the application code may store the results of its analysis for later reporting or functionality.

In some embodiments, at step 620, the system 100 may configure the application code to investigate the current plurality of attributes of the web content upon a browser loading the element of web content. In such embodiments, the application code may be triggered when a browser seeks to load the element of web content. This may occur, for example, when a browser begins to load an HTML page, or a portion of an HTML page, or a separate application (e.g., JavaScript™ application).

In some embodiments, at step 630, the system 100 may configure the application code to investigate the current plurality of attributes of the web content upon a browser refreshing the element of web content. In some situations, the browser may be set up to automatically refresh its content periodically. Alternatively, a backend web server may push updates to the web content to the client. Further, users of the client may manually refresh the content of the web browser. In any situation, the application code may be configured to perform its investigation when such events happen.

In some embodiments, at step 640, the system 100 may configure the application code to investigate the current plurality of attributes of the web content upon detecting changes in the element of web content. Because web content may be dynamically changed without reloading or refreshing the element of web content, the application code may be triggered based on detecting whether there are any changes in the element of web content. Configuring the application code to be triggered based on certain actions may reduce browser redirect attacks that causes the browser to either load, refresh, or change certain web content.

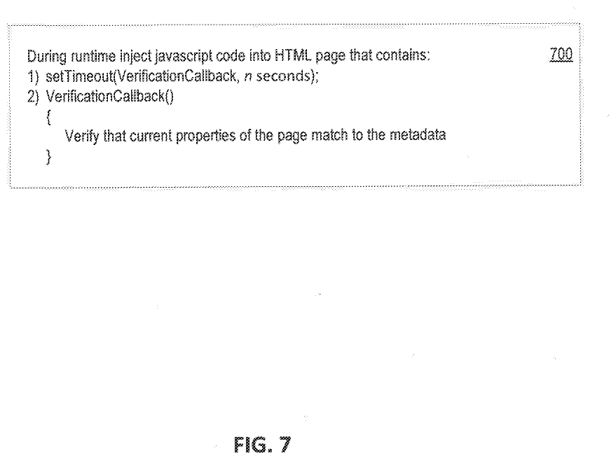

FIG. 7 is a diagram illustrating an exemplary application code 700 that may be used to detect client-side exploits in accordance with disclosed embodiments. The application code of FIG. 7 may be implemented in software, hardware, or any combination thereof. For purposes of explanation and not limitation, the following describes exemplary application code in the context of systems 100 and 200, such that the disclosed application code 700 may be performed by software executing in mobile devices 102, 104, 106, and/or computing devices 108, 110.

In some embodiments, application code 700 may be configured to inject a code segment into an element of web content to detect client-side exploits. For example, the application code 700 may be configured to inject JavaScript™ code during runtime of a HTML webpage. The application code 700 may further configure the JavaScript™ timing events. For example, as shown in FIG. 7, the application code 700 may configure the JavaScript™ to execute based on a predefined time. One method is to use the setTimeout(function, time) method. The setTimeout( ) method will execute a function after waiting a specified amount of time. Alternatively, the application code 700 may configure the JavaScript to execute based on a predefined interval. One method is to use the setInterval(function, time) method. The setInterval( ) method will execute a function the same as setTimeout( ) but will repeat the execution of the function continuously.

The application code 700 may further configure the JavaScript™ code to perform a function to verify that the current properties of the webpage match the metadata associated with the webpage in accordance with disclosed embodiments to detect potential client-side exploits.

To further illustrate various of the example embodiments, the exemplary process 500 will now be described in the context of exemplary use cases with respect to a web application implemented in systems 100 and 200. The following examples should not be construed as limiting and/or exhaustive, but rather, as illustrative use cases to show an implementation of at least one of the disclosed embodiments for detecting client-side exploits.

As discussed, XSS attacks are a type of injection attacks where malicious scripts are injected into HTML webpages. By using XSS to send a malicious script, an end user's browser 218 has no way to know that the malicious script should not be trusted and will execute the malicious script. Once executed, the malicious script can access any cookies, session tokens, or other sensitive information and can even rewrite the content of the HTML webpage.

Process 500 may be used to detect XSS exploits by determining whether an XSS exploit exists in a web application. The web application may be a client-server application where the user interface and application logic are implemented in a browser 218 on system 200. The web application may be implemented using HTML and JavaScript™.

The web server and/or application server 110 may generate metadata describing an initial plurality of attributes of the original web application. As an example, the web application may have an initial plurality of attributes including no frames and a fillable form with 10 fields. The metadata may be stored as part of the original web application, which provides a reference for the initial plurality of attributes in the web application (i.e., zero frames and 10 fields). The original web application may further contain a JavaScript™ code that detects potential XSS exploits.

When the end user access the web application via a browser 218 on system 200, the browser 218 sends an HTTP request message to the web server and/or application server 110 to request the web application. Along with the web application, the web server and/or application server 110 sends the JavaScript™ code and metadata to the browser 218. The browser 218 may then start its rendering process to parse the web application for display to the end user.

During the runtime of the web application, the JavaScript™ code may be configured to run periodically to detect XSS exploits. The JavaScript™, for example, may cause the system 200 to determine a current plurality of attributes of the rendered web application. The system 200 may compare the initial plurality of attributes to the current plurality of attributes to identity a mismatch. For example, the system 200 may determine that the rendered web application contains an iframe pulling in another external HTML webpage and a form with 12 fields. The system 200 may compare the current plurality of attributes (i.e., one iframe and 12 fields) with the expected or reference attributes from the metadata (i.e., zero frames and 10 fields) and identify a mismatch between the metadata that describes the various expected properties of the web application with the runtime properties of the same web application.

The system 200 may then determine that a potential client-side exploit exists in the web application because the runtime properties of the web application contains two additional fields and an additional iframe.

As an additional exemplary use case, process 500 may also be used to detect XSS exploits by an intermediary entity such as a proxy or a firewall that resides between the client device and the web server. For example, the proxy or firewall may access the web application hosted on the web server and/or application server 110 to generate metadata describing an initial plurality of attributes of the web application. Continuing with the earlier example, the web application may have an initial plurality of attributes including no frames and a finable form with 10 fields, and the metadata may provide a reference for the initial plurality of attributes in the web application (i.e., zero frames and 10 fields).

When the end user access the web application via a browser 218 on system 200, the proxy or firewall may intercept the HTTP request and response messages to and from the web server and/or application server 110. By intercepting the HTTP request and response, the proxy or firewall may inject a JavaScript™ code that detects potential XSS exploits into the web application. In some embodiments, the metadata may also be inserted into the web application.

During the runtime of the web application, the JavaScript™ code may be configured to run periodically to detect XSS exploits. For example, the JavaScript™ may cause the system 200 to determine a current plurality of attributes of the rendered web application. The system 200 may compare the initial plurality of attributes to the current plurality of attributes to identity a mismatch, Continuing with the example provided in the first use case, the system 200 may determine that the rendered web application contains an iframe pulling in another external HTML webpage and a form with 12 fields. The system 200 may compare the current plurality of attributes (i.e., one iframe and 12 fields) with the expected or reference attributes from the metadata (i.e., zero frames and 10 fields) and identify a mismatch between the metadata that describes the various expected properties of the web application with the runtime properties of the same web application. The system 200 may then determine that a potential client-side exploit exists in the web application because of the mismatch.

In another use case, the comparison process may be performed by external services such as, for example, a proxy, firewall, web server, application server, etc. As explained with respect to process 500, the injected JavaScript™ code may cause the client device to collect the runtime properties of the web application, Continuing with the example provided in the first use case, the system 200 may determine that the rendered web application contains an iframe pulling in another external HTML webpage and 12 fields, Δt a certain point in time, the JavaScript™ code may cause the client device's browser 218 to initiate an AJAX call to the external services to perform the detection process. The client device may provide the current runtime properties (i.e., one iframe and 12 fields) to the external services via the AJAX call. Once the external services receive the AJAX call and current runtime properties, the external services may compare the current runtime properties of the web application with the metadata to determine whether a potential client-side exploit exists. In response to the AJAX call, the external services may send an indication of the exploit status of the web application to the client device.

Using the exemplary process 500, the systems 100, 200 may detect client-side exploits. Exemplary process 500 may be used to minimize the attack surface of the systems 100, 200 and to reduce injection-type cyberattacks by detecting anomalies occurring in the client devices of the systems 100, 200. As a result, the disclosed embodiments reduce the vulnerabilities and weaknesses associated with web applications and other client applications.

The disclosed embodiments may be implemented in a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods and computer program products according to various embodiments of the present invention. In this regard, each block in the flowcharts or block diagrams may represent a software program, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant virtualization platforms, virtualization platform environments, trusted cloud platform resources, cloud-based assets, protocols, communication networks, security tokens and authentication credentials will be developed and the scope of these terms is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. A non-transitory computer readable medium including instructions that, when executed by at least one processor, cause the at least one processor to perform operations for detecting potential client-side exploits in web content, the operations comprising:
identifying metadata associated with an element of web content, the metadata describing an initial plurality of attributes of the element of web content;
inserting application code into the web content, the application code being executable by a browser that processes the element of web content;
wherein the inserted application code is configured to determine a current plurality of attributes of the element of web content;
comparing the initial plurality of attributes of the element of web content to the current plurality of attributes of the element of web content; and
determining, based on the comparison, whether a potential client-side exploit exists in the element of web content.

2. The non-transitory computer readable medium of claim 1, wherein the initial plurality of attributes specify a permitted range for the element of web content.

3. The non-transitory computer readable medium of claim 1, wherein the element of web content is an HTML page.

4. The non-transitory computer readable medium of claim 1, wherein the element of web content is a script application.

5. The non-transitory computer readable medium of claim 1, wherein the plurality of attributes include a number or range of scripts in the element of web content.

6. The non-transitory computer readable medium of claim 1, wherein the plurality of attributes include a number or range of forms in the element of web content.

7. The non-transitory computer readable medium of claim 1, wherein the plurality of attributes identify a uniform resource identifier in the element of web content.

8. The non-transitory computer readable medium of claim 1, wherein the plurality of attributes include a number or range of frames in the element of web content.

9. The non-transitory computer readable medium of claim 1, wherein the plurality of attributes identify an external library that is used by the element of web content.

10. The non-transitory computer readable medium of claim 1, wherein the plurality of attributes identify a whitelisted uniform resource locator in the element of web content.

11. The non-transitory computer readable medium of claim 1, wherein the plurality of attributes identify types of uniform resource locators in the element of web content.

12. The non-transitory computer readable medium of claim 1, wherein the plurality of attributes identify types of scripts in the element of web content.

13. The non-transitory computer readable medium of claim 1, wherein the plurality of attributes identify types of forms in the element of web content.

14. A computer-implemented method for detecting potential client-side exploits in web content, the method comprising:
identifying metadata associated with an element of web content, the metadata describing an initial plurality of attributes of the element of web content;
inserting application code into the web content, the application code being executable by a browser that processes the element of web content;
wherein the inserted application code is configured to determine a current plurality of attributes of the element of web content;
comparing the initial plurality of attributes of the element of web content to the current plurality of attributes of the element of web content; and
determining, based on the comparison, whether a potential client-side exploit exists in the element of web content.

15. The computer-implemented method of claim 14, further comprising inserting the metadata into the element of web content, and performing the comparison by the inserted application code.

16. The computer-implemented method of claim 14, further comprising receiving the current plurality of attributes of the element of web content, and performing the comparison external to the element of web content.

17. The computer-implemented method of claim 16, wherein the metadata is stored external to the element of web content.

18. The computer-implemented method of claim 16, wherein the current plurality of attributes of the element of web content are received in response to an AJAX call.

19. The computer-implemented method of claim 18, wherein the AJAX call includes a prompt to perform the comparison.

20. The computer-implemented method of claim 14, wherein the application code is configured to periodically investigate the current plurality of attributes of the web content.

21. The computer-implemented method of claim 14, wherein the application code is configured to investigate the current plurality of attributes of the web content upon a browser loading the element of web content.

22. The computer-implemented method of claim 14, wherein the application code is configured to investigate the current plurality of attributes of the web content upon a browser refreshing the element of web content.

23. The computer-implemented method of claim 14, wherein the application code is configured to investigate the current plurality of attributes of the web content upon detecting changes in the element of web content.
